(19) United States
(12) Patent Application Publication
(10) Pub. No.: US 2026/0281890 A1
(43) Pub. Date: Sep. 17, 2026

(54) METHODS AND APPARATUS FOR WTRU MEMBER SELECTION USING OBSERVED SERVICE EXPERIENCE FILTERING CRITERIA

(71) Applicant: INTERDIGITAL PATENT HOLDINGS, INC., Wilmington (DE)

(72) Inventors: Ulises Olvera-Hernandez, Saint-Lazare (CA); Samir Ferdi, Kirkland (CA); Achref Methenni, Montreal (CA); Mohamad Kenan Al-Hares, Canterbury (GB)

(73) Assignee: INTERDIGITAL PATENT HOLDINGS, INC., Wilmington (DE)

(21) Appl. No.: 19/167,545

(22) PCT Filed: Apr. 5, 2024
(86) PCT No.: PCT/US2024/023343

§ 371 Date: Sep. 22, 2025

Related U.S. Application Data
(60) Provisional application No. 63/457,674, filed on Apr. 6, 2023.

(51) Int. Cl. H04W 48/20

(52) U.S. Cl. CPC H04W 48/20

(57) ABSTRACT

Techniques for member selection include sending, to a network node, a request for wireless transmit/receive unit (WTRU) selection assistance for federated learning operations. The request includes an indication of a first list of candidate WTRUs, an indication of at least one filtering criteria, and an indication of a contribution weight for each WTRU indicated in the first list. A notification is received from the network node. The notification includes a second list of a subset of the candidate WTRUs. The second list is based on a service experience metric, weighted based on the contribution weight, that meets the at least one filtering criteria.

### CROSS-REFERENCE TO RELATED APPLICATIONS

This application claims the benefit of U.S. Provisional Application No. 63/457,674, filed Apr. 6, 2023, the contents of which are incorporated herein by reference.

### BACKGROUND

A Network Data Analytics Function (NWDAF) may provide Observed Service experience analytics to a Service Consumer, such as a Network Function (NF) or an Application Function (AF). An observed Service Experience may be an average of observed Service Mean Opinion Score (MoS) and/or variance of observed Service MoS indicating service MoS distribution for services, such as audio-visual streaming, as well as services that are not audio-visual streaming, such as V2X and Web Browsing services. Observed Service Experience can be provided for a wireless transmit/receive unit (WTRU) or a group of WTRUs in a specific network slice (e.g., Single-Network Slice Selection Assistance Information (S-NSSAI), a WTRU or a group of WTRUs running a specific application (e.g., Application ID), a WTRU or a group of WTRUs applying a Rule Selection Component (e.g., S-NSSAI, Data Network Name (DNN), Protocol Data Unit (PDU) Session Type, Secondary Component Carrier (SSC) Mode, and/or Access Type), a WTRU or a group of WTRUs in a specific Radio Access Technology (RAT) Type or Frequency, and/or a WTRU or a group of WTRUs in a specific UP path transporting traffic for an EDGE application As part of the conclusions reached at the end of the Study of 5G System Support for AI/ML-based Services, 3GPP TR 23.700-80, it was agreed that whether Service Experience analytics can be used can be discussed during the normative phase.

### SUMMARY

Methods and apparatus for member selection are described herein. A method includes sending, to a network node, a request for wireless transmit/receive unit (WTRU) selection assistance for federated learning operations. The request includes an indication of a first list of candidate WTRUs, an indication of at least one filtering criteria, and an indication of a contribution weight for each WTRU indicated in the first list, wherein the indication of the contribution weight indicates a minimum relative importance of a service experience of each of the WTRUs indicated in the first list based on at least one of a service experience type, a time or a location. A notification is received from the network node. The notification includes a second list of a subset of the candidate WTRUs. The second list is based on a service experience metric, weighted based on the contribution weight, that meets the at least one filtering criteria.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal diagram of an example of a WTRU member selection framework;

FIGS. 3A and 3B are a signal diagram of an example method of WTRU member selection assistance based on Service Experience filtering;

FIG. 4 is a signal diagram of an example method for WTRU member selection assistance based on network slice availability analytics; and

FIG. 5 is a flow diagram of an example method for WTRU member selection assistance.

### DETAILED DESCRIPTION

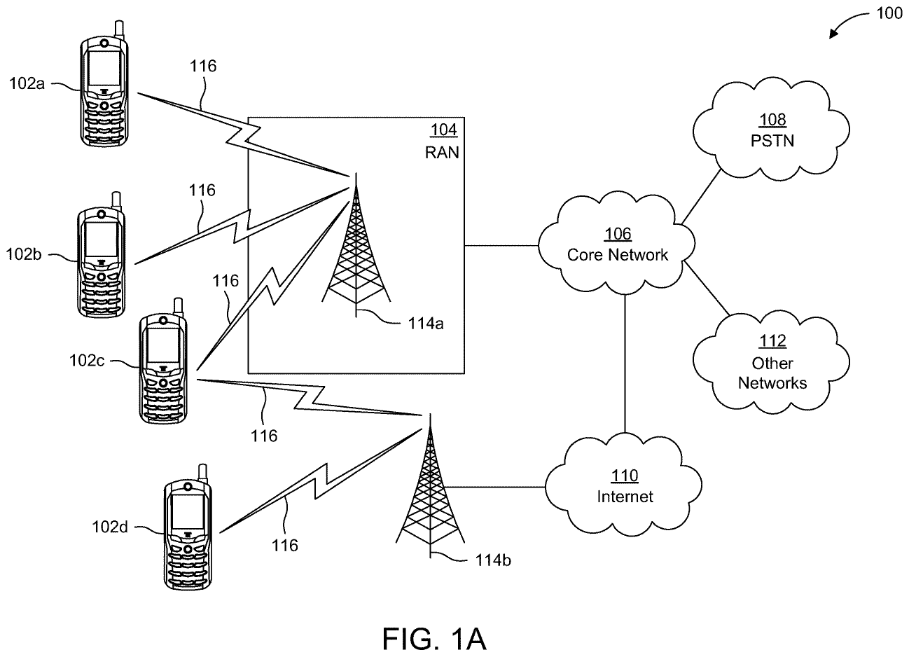

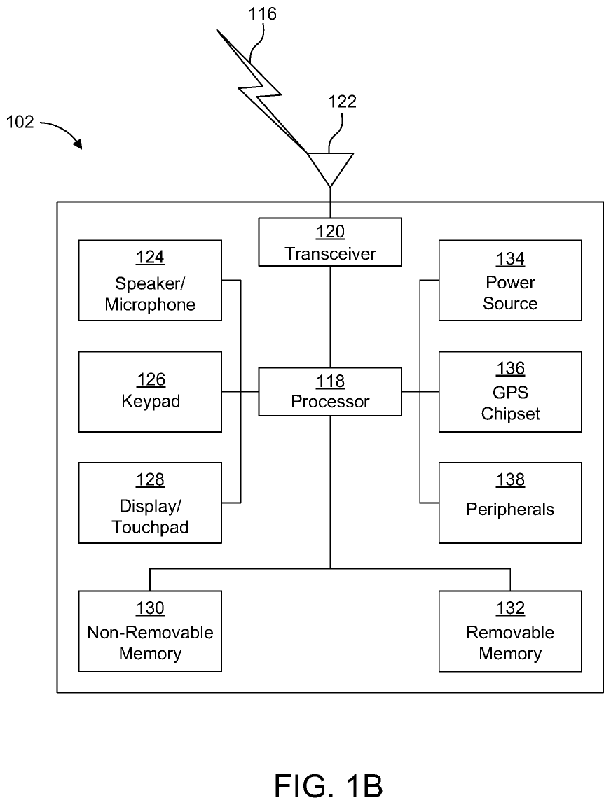

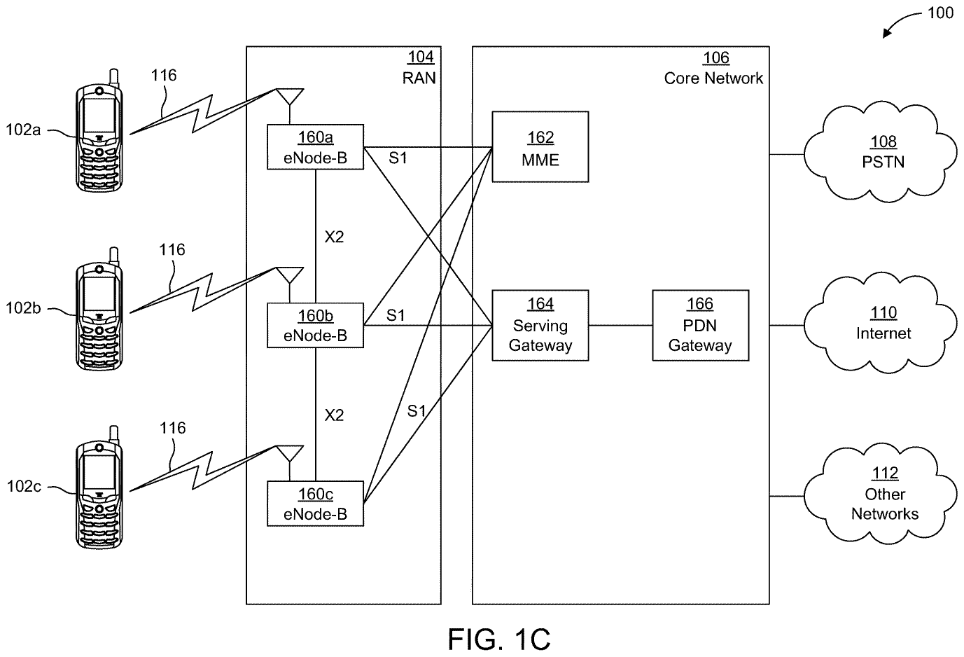

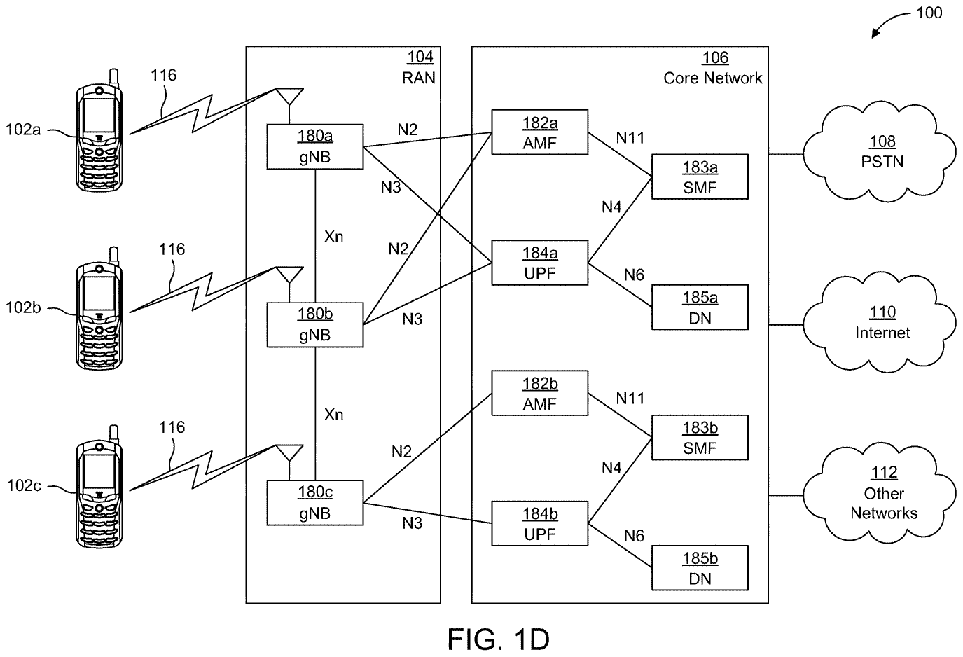

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUS 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

5GS assistance for member selection functionality may enable an AF to request assistance from the 5GS in the selection of WTRUs that the AF may consider when supporting certain applications, such as Federated Learning. The AF may provide an initial list of target WTRUs, filtering criteria and other details, such as time window, when the 5GS is expected to select candidate members. The 5GS may use the filtering criteria from the AF to derive the operations that enable the 5GS to collect data from relevant Network Functions and, thus, identify candidate WTRUs. For example, the network exposure function (NEF) may use QoS requirements as filtering criteria to select candidate members.

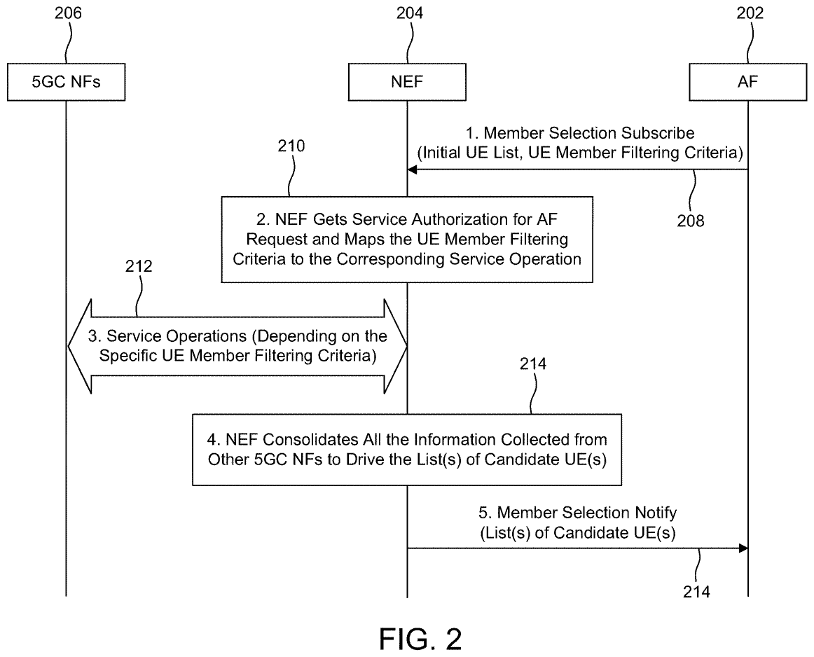

FIG. 2 is a signal diagram of an example of a WTRU member selection framework. In the example illustrated in FIG. 2, an AF 202 may send a member selection subscribe message to the NEF 204, which may include, for example, an initial WTRU list and WTRU member filtering criteria (208). The NEF 204 may get Service Authorization for the AF request and may map the WTRU member filtering criteria to a corresponding service operation (210). The NEF 204 may provide service operations to the 5GC NFs 206 (212), which may depend on the specific WTRU member filtering criteria. The NEF 204 may consolidate all the information collected from other 5GC NFs 206 to derive the list of list of candidate WTRUs (214). The NEF 204 may send a member selection notify message to the AF (216), which may include, for example, a list of candidate WTRUs.

Federated Learning (FL) follows a collaborative training approach where each device uses local training data to train local models, and the servers generate a global model by combining the local model's parameters. However, FL is vulnerable to system heterogeneity, for example, when local devices have varying computational, storage or communications capabilities. It may, thus, be critical for the AF to weed out low performance devices that may severely impact the FL operations by delaying convergence. As mentioned above, it was agreed that whether Service Experience analytics can be used can be discussed during the normative phase, however, it is not clear how Service Experience can be requested by the AF and used by the NEF to conduct WTRU member Selection since conventional systems enable service consumers to request Service Experience but do not go further as to how Service Experience analytics can aid in the process of selecting WTRU members, for example for Federating Learning operations. Embodiments described herein may provide solutions for requesting member selection assistance to identify members based on Service Experience over a certain path leading to an Edge Computing Network (ECN), requesting member selection assistance to identify members in a sub-slice location to narrow the search for candidate WTRUs, requesting member selection assistance to identify members based on reputation metric or certain weight the AF may provide to the 5GC, and requesting member selection assistance to identify members based the type of Service Experience being measured, e.g., whether the Service Experience is being measured on services delivering AIML federating learning operations, AIML model/data distribution or AIML split operations.

In conventional 5G Systems, a service consumer may request service experience at different levels, for one or many WTRUs. Depending on the service consumer, service consumer analytics may be used differently. For example, the Session Management Function (SMF) may consider service experience analytics per UP path to select a target data network access identifier (DNAI) and, thus, determine whether a UPF in the data path should be removed.

With the introduction of WTRU member selection functionality, the NEF is expected to provide WTRU member candidates taking into consideration data collection from other NFs. However, the current filtering criteria that the NEF uses to derive the WTRU candidate list does not take into consideration the relative impact on an application operation when WTRUs with suboptimal service experience are included in the list, even when, for example, the quality of service (QoS) measurements for that WTRU may show to be above an acceptable threshold.

Mechanisms are described herein that may include WTRU service experience analytics in the selection of WTRU member candidates, while allowing the AF to request filtering criteria considering weighting factors, service experience type, and specific UP paths on a given network slice. An advantage of this enhancement may be that, by including the service experience filtering criteria, the AF may ensure that the NEF filters in/out WTRUs considering their MoS, which may have been derived from aspects, such as computation capacity, storage or battery capacity. For example, this may enable more performance overall during FL operations and ensure an optimal model convergence.

In some embodiments, an AF may first request WTRU member selection assistance and provide Observed Service Experience filtering criteria that may takes the presence of straggling WTRUs into consideration. For example, by using contribution weight, the AF consumer may provide a minimum relative importance to target WTRUs from the list to provide to the NEF. The contribution weights associated to target WTRUs may have different values depending on the location, time window, access type, Service Experience Type, and/or a WTRU reputation or trustworthiness metric. The AF may map an application Artificial Intelligence (AI) Machine Learning (ML) (AIML) operation to an Application Id and a Service Experience type and may associate the Service Experience type to a customized MoS, for example based on the Service Level Agreement (SLA) between the Application Service Provider (ASP) and the Mobile Network Operator (MNO). The AF may request that the Service Experience be measured on a particular area, either by providing a list of DNAIs, a geographical location, or location availability information matching a Network Slice Area of Service. It may also associate contribution weights to such location. The AF may request that the Observed Service Experience be complemented with Performance Data from one or more AF producers, on specific AS instances and locations and for specific Application IDs, S-NSSAI/DNN, for example by providing specific DNAls and specific service flows.

In some embodiments, an NEF may use the AF request, including the Service Experience filtering criteria, in combination with other filtering information such as, QoS filtering, to derive the associated Service Experience service data. The NEF may use service experience contribution weights included in the Service Experience filtering criteria to select WTRU member candidates, based on the Service Experience service data collected from the AF producer and other NFs, such as SMF/UPF.

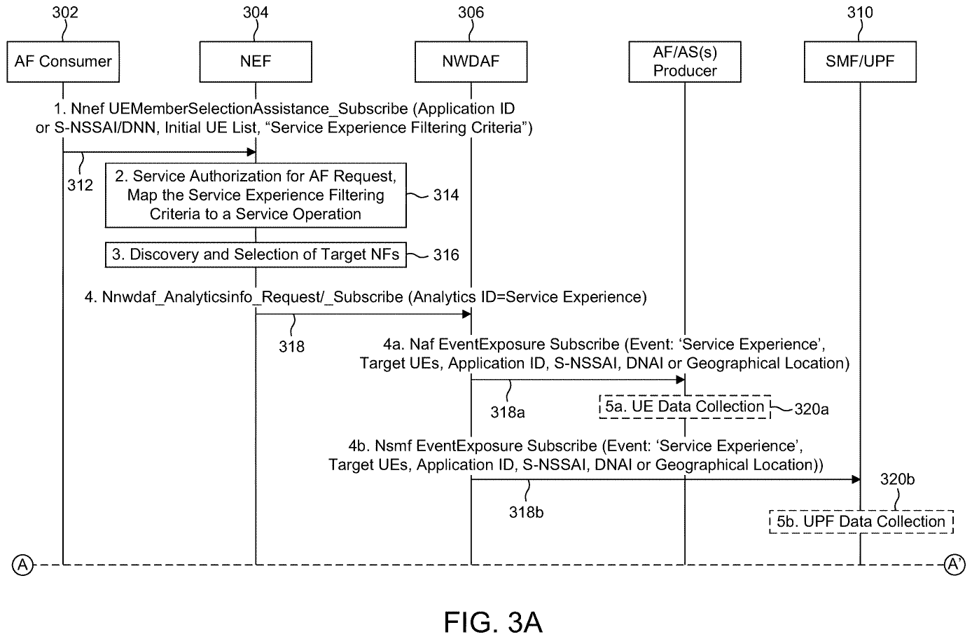

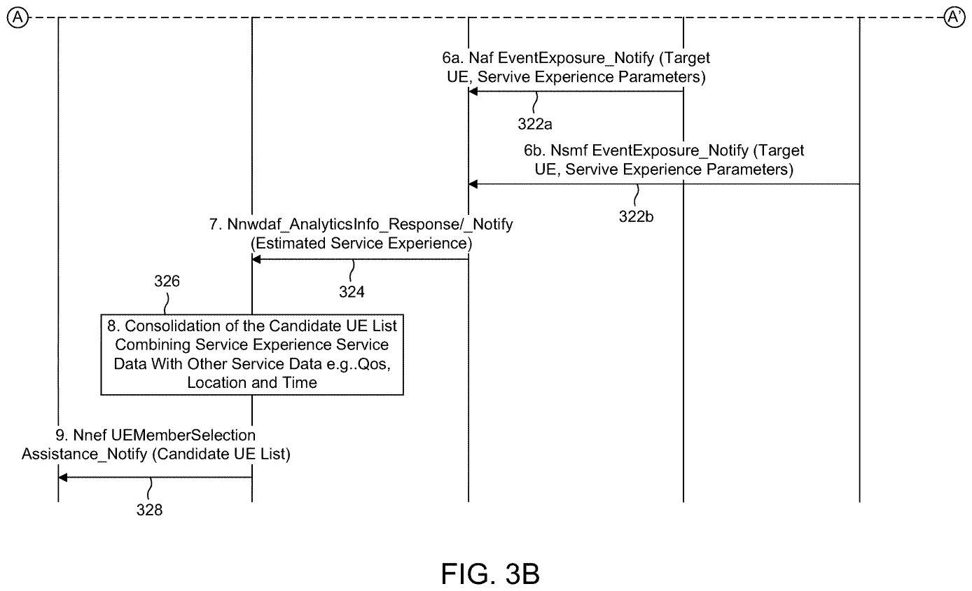

FIGS. 3A and 3B are a signal diagram of an example method of WTRU member selection assistance based on Service Experience filtering. In the example illustrated in FIG. 3, the AF consumer 302 may request WTRU member selection assistance (312) by providing Observed Service Experience filtering criteria and, in some embodiments, other related filtering criteria, such as QoS filtering criteria. The AF consumer 302 may include in the Observed Service Experience filtering criteria contribution weights associated to location, time window, Application ID and Service Experience type. By way of example, contribution weights may be provided to favor Service Experience type relative to Federated Learning in a particular location and even may be associated to a trustworthiness or reputation metric trustworthiness (e.g., based on historical performance/contribution exposed by the WTRU).

The NEF 304 may request service authorization for the AF consumer request and map the received Service Experience filtering criteria in combination with other related filtering criteria, such as QoS filtering criteria, to one or more service operation (314). For example, the NEF 304 may derive service operations to request analytics from the NWDAF 306 or request QoS monitoring from the SMF or UPF 310. The NEF 304 may perform discovery and selection of the relevant NF producers (316), supporting the service operations obtained in (314). The NEF 304 may subscribe to Service Experience Analytics and may subscribe to QoS monitoring (318-324) . The NEF 304 may use the Service Experience type provided by the AF consumer 302 to use operator policies to interpret a customized MoS (326). The NEF 304 may use the contribution weight associated to an application and a Service Experience Type (e.g., an application AIML operation) and applied to a location, time window, access type and/or reputation or trustworthiness, as provided by the AF consumer 302, to be used as reporting thresholds when selecting WTRU candidate members. For example, a WTRU located in a Network Slice Area of Service, connected through a DNAI, and running an application which Type of Service Experience is associated to a application AIML operation, may be considered a WTRU member candidate if its Application Service Experience is above the reporting threshold. The NEF 304 may notify the result of the WTRU member selection including the list of candidate WTRU members (328). The NEF 304 may notify the AF 302 periodically about the selected WTRU members based on change of the conditions/context experienced by one or more selected WTRUs with respect to the Observed Service Experience filtering criteria and other filtering criteria described above.

In some embodiments, the WTRU member selection assistance may be enhanced. For example, the NWDAF 306 may be enhanced to provide new analytics information or predictions regarding slice availability duration information (e.g., how long will a slice be available to the WTRU before it becomes unavailable due to mobility or other factors). The NWDAF 306 may collect WTRU mobility information and slice availability information and provide predictions of how long the WTRU will stay registered in the slice before it becomes unavailable due do RA restriction, NSSRG restriction, NSACF change, NSA, etc. In some embodiments, the NWDAF 306 may produce analytics information or predictions for WTRU availability time at certain locations (e.g., how long the WTRU will be available in a certain location or in a certain area). The application may want to engage WTRUs for a certain period in a certain area.

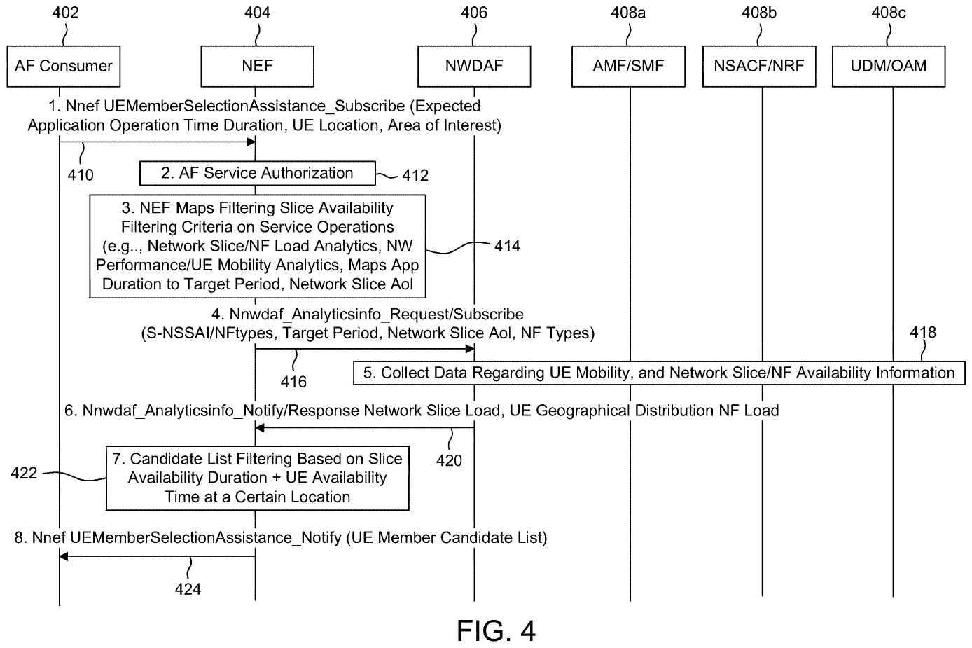

FIG. 4 is a signal diagram of an example method for WTRU member selection assistance based on network slice availability analytics. In the example illustrated in FIG. 4, the AF consumer 402 may subscribe to WTRU member selection assistance from the 5GS (through the NEF 404), for example to obtain WTRU candidate members for a specific application, such as an application AIML operation (410). The AF consumer 402 may provide an initial list of WTRUs to be considered for the selection process as well as filtering criteria to be considered by the 5GS for the WTRU member selection. In some embodiments, the expected application operation time duration, indicating how long the AF consumer 402 is expecting the application operation to be running, may be included in the filtering information. In some embodiments, the filtering parameters may be the same for all WTRUs (e.g., one duration or window of time), or it may be tailored for different WTRUs. The expected application operation time may be based on the AF-consumer-provided deregistration inactivity PDU Session inactivity timer value for a specific S-NSSAI provided to the 5GS using the External Parameter Provisioning operation when the 5GS authorizes the AF consumer 402 to do so, if the 5GS assigns the AF consumer a dedicated S-NSSAI.

The filtering criteria may also include WTRU location and Area of interest. This criterion may indicate that the application is interested in WTRUs that are in a certain location or certain locations or area of interest. The filtering criteria may also include S-NSSAI and DNN information, to specify the network slice that the AF consumer wants to use, when running a specific application, application AIML Federated Learning, for example. If the AF consumer does not provide the S-NSSAI/DNN, the 5GC may detect the S-NSSAI of interest from the AF consumer identifier and may use that information later when using the slice related statistics or predictions for WTRU member selection assistance.

The NEF 404 may authorize the AF request (412). The NEF may use the Expected Application Operation time duration included in the Filtering Criteria to determine a service operation that provides Network Slice availability, at a particular time and at a particular location, which the NEF 404 may use to derive candidate WTRU members (414). In some embodiments, the NEF 404 may use NF load statistics and predictions and Slice Load Statistics and Predictions to determine the slice/NF availability, and the NEF 404 may use the Network Performance Statistics and Predictions and WTRU mobility Statistics and Predictions to determine WTRU mobility Patterns toward Network Slices that may or may not be available for certain duration and at certain location. For the initial list of WTRUs that the AF provided, the NEF 404 may be interested to know how long the slice of interest will be available to the WTRU. Additionally, the NEF 404 may be interested to know, in certain locations, how long the WTRU will be available in that location.

The NEF 404 may request analytics from the NWDAF 406 providing slice availability duration information for other WTRUs not initially in the list and providing some candidate WTRUs whose slice availability duration satisfies a certain minimum threshold, or WTRUs that will be available at certain locations for a minimum of time. The NEF 404 may consider these WTRUs later when responding to the AF.

The NEF 404 may request relevant analytics from the NWDAF 406, and it may include, in the request, S-NSSAI/NF types, Target Period, Network Slice Aol, NF types to signal when and where and for which NFs/Network Slices analytics are being requested (416). The NWDAF 406 may collect relevant input data from different network functions 408a, 408b, 408c regarding WTRUs' locations, WTRUs' mobility information and slice information for WTRUs (418). The NWDAF 406 may respond or notify the NEF 404 about the Network Slice Load, NF load, WTRU geographical distribution and WTRU actual/predicted location and WTRU direction (420). The NWDAF 406 may generate a candidate list of WTRUs after collecting analytics from the NWDAF and may determine Network Slice availability duration and WTRU availability time at a certain location (422). The NEF 404 may identify a larger candidate list of WTRUs than the initial list provided by the AF consumer 402 and may include these WTRUs when in the final member candidate list (424).

For example, the NEF 404 may compare, for each WTRU, the WTRU slice availability duration with the Expected application operation time duration provided by the AF. If the WTRU slice availability duration prediction is greater than or equal to the expected operation time value, the WTRU may be selected. Otherwise, the WTRU may not be selected. The NEF may include new WTRUs that are not in the initial list that, for example, have a WTRU slice availability duration more than the expected application time duration.

Similarly, the NEF 404 may compare WTRU duration at a certain location against the filtering criteria regarding the WTRU location, area of interest and expected operation time duration. In this case, if a WTRU will be available (based on predictions from the NWDAF) at a certain location or in a certain area of interest, for a duration that exceeds the expected application operation time duration, then the WTRU may be a good candidate for the AIML operation and may be selected. Otherwise, the WTRU may not be selected. Similarly, the NEF 404 may include WTRUs not initially included in the WTRU list that satisfy this criteria. The WTRU slice availability duration and WTRU availability at a certain location may be used separately or together during the WTRU member selection assistance process.

For example, a scenario may be considered where the AF is only interested in no service interruption, regardless of the location. The AF in this case may provide only expected operation time duration in the filtering criteria, and not necessarily the WTRU location. In this case, the NEF may request only WTRU slice availability duration predictions from the NWDAF and not WTRU location-based analytics.

After filtering the list of WTRUs and obtaining a final list of WTRUs that satisfy the criteria provided by the AF, the NEF may forward the list of candidate WTRUs to the AF (424).

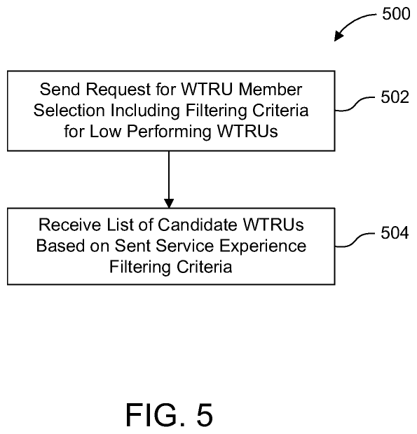

FIG. 5 is a flow diagram of an example method 500 for WTRU member selection assistance. In the example illustrated in FIG. 5, a request may be sent for WTRU member selection that may include filtering criteria for low performing WTRUs (502). The request may be for member selection assistance for federated learning operations and may include a preliminary list of candidate WTRUs. A list of candidate WTRUs may be received from the network node based on the sent service experience filtering criteria (504).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
sending, to a network node, a request for member wireless transmit/receive unit (WTRU) selection assistance, wherein the request includes an indication of a first list of WTRUs, an indication of at least one service experience filtering criterion, and indications of contribution weights corresponding to each WTRU indicated in the first list, wherein the contribution weights are based on at least one of a service experience type, a time window, or a location; and
receiving, from the network node, a notification, wherein the notification includes an indication of a second list of candidate WTRUs that is a subset of the first list of WTRUs, wherein the WTRUs indicated in the second list each have a service experience metric, weighted based on the corresponding contribution weight, that meets the at least one service experience filtering criterion.

2. The method of claim 1, wherein the contribution weights favor one or more service experience types.

3. The method of claim 1, wherein the at least one service experience filtering criterion includes the contribution weights for the WTRUs in the first list that have different values depending on at least one of application identifier (ID), WTRU reputation or WTRU trustworthiness.

4. The method of claim 1, wherein the at least one service experience filtering criterion is based on observed service experience, and associates the service experience type or an application to a particular location.

5. The method of claim 1, further comprising sending a request, to the network node, for observed service experience analytics for an artificial intelligence machine learning (AIML) application operation, wherein the observed service experience analytics is performed by mapping the AIML application operation to an application identifier (ID) and a service experience type.

6. The method of claim 5, wherein the observed service experience analytics is further performed by requesting the service experience to be a customized mean opinion score (MoS).

7. The method of claim 5, wherein the request for observed service experience analytics includes a request that the observed service experience be complemented with performance data from application function producers on specific application service instances and locations.

8. The method of claim 7, wherein the request for observed service experience analytics further includes a request that the observed service experience be complemented with performance data for at least one of specific application IDs, network slice selection assistance information (S-NSSAI), or data network name (DNN).

9. The method of claim 1, further comprising sending a request, to the network node, that service experience be measured on a particular area.

10. The method of claim 9, wherein the request that service experience be measured on a particular area provides at least one of a list of data network access identifiers (DNAIs), a geographic location, or location availability information matching a network slice area of service.

11. A device, comprising:
a transmitter that sends, to a network node, a request for member wireless transmit/receive unit (WTRU) selection assistance wherein the request includes an indication of a first list of WTRUs, an indication of at least one service experience filtering criterion, and indications of contribution weights corresponding to each WTRU indicated in the first list, wherein the contribution weights are based on at least one of a service experience type, a time window, or a location; and
a receiver that receives, from the network node, a notification that includes an indication of a second list of candidate WTRUs that is a subset of the first list of WTRUs, wherein the WTRUs indicated in the second list each have a service experience metric, weighted based on the corresponding contribution weight, that meets the at least one service experience filtering criterion.

12. The device of claim 11, wherein the contribution weights favor one or more service experience types.

13. The device of claim 11, wherein the transmitter sends a request, to the network node, for observed service experience analytics for an artificial intelligence machine learning (AIML) application operation.

14. The device of claim 13, wherein the observed service experience analytics is performed by mapping the AIML application operation to an application identifier (ID) and a service experience type, wherein the observed service experience analytics is further performed by requesting the service experience to be a customized mean opinion score (MoS).

15. The device of claim 14, wherein the at least one service experience filtering criterion is based on observed service experience, and associates the service experience type or an application to a particular location.

16. The device of claim 15, wherein the request for observed service experience analytics includes a request that the observed service experience be complemented with performance data from application function producers on specific application service instances and locations.

17. The device claim 16, wherein the request for observed service experience analytics further includes a request that the observed service experience be complemented with performance data for at least one of specific application IDs, network slice selection assistance information (S-NSSAI), or data network name (DNN).

18. The device of claim 11, further comprising sending a request, to the network node, that service experience be measured on a particular area by providing at least one of a list of data network access identifiers (DNAIs), a geographic location, or location availability information matching a network slice area of service.

19. The device of claim 11, wherein the device is an application function consumer.

20. The device of claim 19, wherein the application function consumer is one of a WTRU or a computer.
